(19) United States
(12) Patent Application Publication
(10) Pub. No.: US 2015/0188149 A1
(43) Pub. Date: Jul. 2, 2015

(54) METAL SEPARATOR FOR FUEL CELL STACK

(71) Applicants: Hyundai Motor Company, Seoul (KR); Kia Motors Corporation, Seoul (KR)

(72) Inventors: Sang Moon JIN, Yongin-si (KR); Yoo Chang YANG, Gunpo-si (KR)

(21) Appl. No.: 14/557,112

(22) Filed: Dec. 1, 2014

(30) Foreign Application Priority Data
Dec. 31, 2013 (KR) 10-2013-0168312

(51) Int. Cl. H01M 8/02; H01M 8/04; H01M 8/24

(52) U.S. Cl. CPC H01M 8/0258; H01M 8/0267; H01M 8/2465; H01M 8/04029; H01M 8/0206

(57) ABSTRACT

A metal separator for a fuel cell stack includes an anode separator, a cathode separator, and a gasket for maintaining airtightness for a reactive gas. The anode separator and the cathode separator are integrated in one set by a bonding portion formed at a contact portion between the anode separator and the cathode separator. The gasket is bonded between the anode separator of the one set and the cathode separator of adjacent sets of the anode and cathode separators. Forming supports that function as channels through which the reactive gas and a cooling water flow and function as structural supports are formed at an inlet and an outlet of the metal separator.

### CROSS-REFERENCE TO RELATED APPLICATION

This application claims under 35 U.S.C. §119(a) the benefit of priority to Korean Patent Application 1 0-201 3-01 6831 2 filed on Dec. 31, 2013, the entire contents of which are incorporated herein by reference.

### TECHNICAL FIELD

The present disclosure relates to a metal separator of a fuel cell stack, and more particularly, to a metal separator for a fuel cell stack which can improve performance and durability of the fuel cells tack with improvement of airtightness and ability of distributing fluid by improving a structure of inlet/outlet for a reactive gas and cooling water of the metal separator.

### BACKGROUND

In general, a fuel cell stack includes a polymer electrolyte film, a membrane electrode assembly (MEA) composed of electrodes on both sides of the polymer electrolyte film, and a pair of gas diffusion layers (GDLs) bonded to the electrodes of the MEA, respectively. The GDLs carry a gas for a reaction with the electrodes. A pair of conductive metal separators supply a reactive gas in close contact with outer sides of the GDLs. A gasket is disposed between the MEA and a separator to prevent leakage of the reactive gas and seal a gap. Further, a current collector and an end plate are attached to an outer side of the metal plates, thereby forming a fuel cell stack.

The metal separator separates hydrogen and oxygen, which are reactive gases, to prevent them from being mixing, electrically connects the membrane electrode assembly, and maintains the shape of the fuel cell stack by supporting the membrane electrode assembly.

Accordingly, the metal separator needs to be precisely structured, needs to have high electric conductivity to function as a conductor, and needs to have sufficient strength for the support function.

Metal separators in the related art are usually manufactured by forming, for example, stamping a thin metal plate to reduce the manufacturing time and cost in comparison to a graphite separator that is machined or powder formed, but there is a design limitation in terms of the airtightness.

For example, when a metal separator is formed by stacks having channels of an anode and a cathode, an airtight structure is required for cooling the plates.

Further, to maintain airtightness for reactive gases in a fuel cell and cooling water with a plurality of separators stacked in series, gaskets are required to maintain the airtightness for the reactive gases at one side and support a gasket at another side.

FIGS. 6 to 8 are perspective and cross-sectional views showing a metal separator of a fuel cell stack of the related art.

Referring to FIG. 6, a gasket 100 comprises a reactive side gasket for maintaining airtightness for hydrogen or air, and a cooling side gasket for maintaining airtightness for cooling fluid. The reactive side gasket and the cooling side gasket are integrally formed by injection molding on the front and back of a metal separator 110 corresponding to an anode or a cathode. The gasket 100 is divided into a main line gasket 100a and a sub-line gasket 100b for the respective airtightness.

The main line gasket 100a is mounted on around an edge of the separator 110 and on an outer side of manifolds to maintain the airtightness between fluids. The sub-line gasket 100b, which is narrower than the main line gasket 100a, supports the main line gaskets and functions as a channel for the gas and the cooling water.

The reference numerals 120, 130, and 140 not described here indicate an air manifold, a cooling water manifold, and a hydrogen manifold, respectively.

FIG. 7 shows a reactive gas inlet structure of the related art, in which a cooling gas flowing inside through the air manifold 120 flows to a reactive side through an inlet hole 150 formed through the separator 110 after passing through the cooling side sub-line gasket 100b. The cooling gas then flows between the sub-line gaskets 100b of the reactive side and to the reactive side.

The non-described reference numeral 160 indicates an MEA.

FIG. 8 describes a cooling side inlet structure, in which a cooling fluid flows directly through the sub-line gasket 100b from a cooling side manifold.

As described above, an inlet and an outlet of the metal separator are formed by a gasket structure in the related art.

In the related art, since there are height differences in components (MEA, GDL, and separator) of each fuel cell, loads applied on the gaskets of the fuel cells are different, and thus, different deformation amount are applied on each gasket.

FIG. 9 is a schematic diagram showing an inlet/outlet cross-section of cells having a standard value and a lower limit value for a thickness of a GDL.

When the standard value is applied, a normal inlet/outlet cross-section is shown. However, when the lower limit value is applied, since a load on a reactive side and a cell pitch are decreased, more load is applied to a gasket, and the gasket is further compressed, thus deforming the inlet/outlet.

When the inlet/outlet in the cell, which is connected in series, becomes narrower, a pressure difference increases, and a smaller amount of reactive gas or cooling water flows inside the fuel cell stack.

FIG. 10 shows a test result of an actual fuel cell vehicle based on the assumption described above.

As expected above and shown in FIG. 10, the cell performance decreases for the cells having a relatively narrower GDL due to reduction of distribution ability for the reactive gas and the cooling water.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

An aspect of the present disclosure provides a metal separator for a fuel cell stack that can improve performance and durability of a stack by implementing an inlet/outlet structure that can improve airtightness and distribution ability by maintaining an inlet/outlet area even when the external conditions change in consideration of a defect of a gasket structure functioning as a channel for reactive gases and cooling water in that the inlet/outlet area changes with the thickness and the fastening conditions of the stack.

According to an exemplary embodiment of the present invention, a metal separator for a fuel cell stack includes an anode separator, a cathode separator, and a gasket for maintaining airtightness for a reactive gas. The anode separator and the cathode separator are integrated in one set by bonding portions formed at their contact portions. The gasket is bonded between the anode separator of the one set and the cathode separator of adjacent sets. Forming supports that function as channels through which the reactive gas and cooling water flow and function as structural supports are formed at an inlet and an outlet of the metal separator.

The bonding portion between the anode separator and the cathode separator may be formed along the entire edge of the separator, an edge of a hydrogen manifold, and an edge of an air manifold.

The forming supports may protrude above the top of the separator at a predetermined level.

The forming supports may protrude to a height corresponding to a thickness of the gasket.

A reactive gas that is supplied to a reactive side may flow into a channel formed inside the forming supports on the separator and may be supplied to the reactive side through inlet holes formed through the separator.

Cooling water that is supplied to a cooling side may flow into a channel formed inside the forming supports and may be supplied to the cooling side through the channel.

The metal separator for a fuel cell stack according to the present disclosure, the anode separator and the cathode separator are integrated, and the forming supports replace a gasket that functions as a channel for a reactive gas and cooling water and as a support, thus improving airtightness and distribution ability by maintaining inlet and outlet areas even if the external conditions change.

Further, uniform distribution of a reactive gas and cooling water to the cells in a fuel cell stack in which a plurality of separators are stacked in series with a thickness tolerance of the separators and GDLs improve performance and durability by maintaining the inlet and outlet areas by improving the gasket structure.

The above and other features of the invention are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure.

FIG. 1 is a perspective view showing a metal separator for a fuel cell stack according to an embodiment of the present disclosure.

FIG. 2 is a cross-sectional view taken along line A-A of FIG. 1.

FIG. 3 is a cross-sectional view taken along the line B-B of FIG. 1.

FIG. 4 is a cross-sectional view taken along line C-C of FIG. 1.

FIG. 5 is a view showing an inlet and an outlet of the present disclosure.

FIG. 6 is a perspective view showing a metal separator of a fuel cell stack of the related art.

FIG. 7 is a cross-sectional view taken along the line D-D of FIG. 6.

FIG. 8 is a cross-sectional view taken along the line E-E of FIG. 6.

FIG. 9 is a view showing an inlet and an outlet of the related art.

FIG. 10 is a graph showing a test result on a fuel cell stack of the related art.

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

Hereinafter, the present disclosure is described in detail with reference to the accompanying drawings.

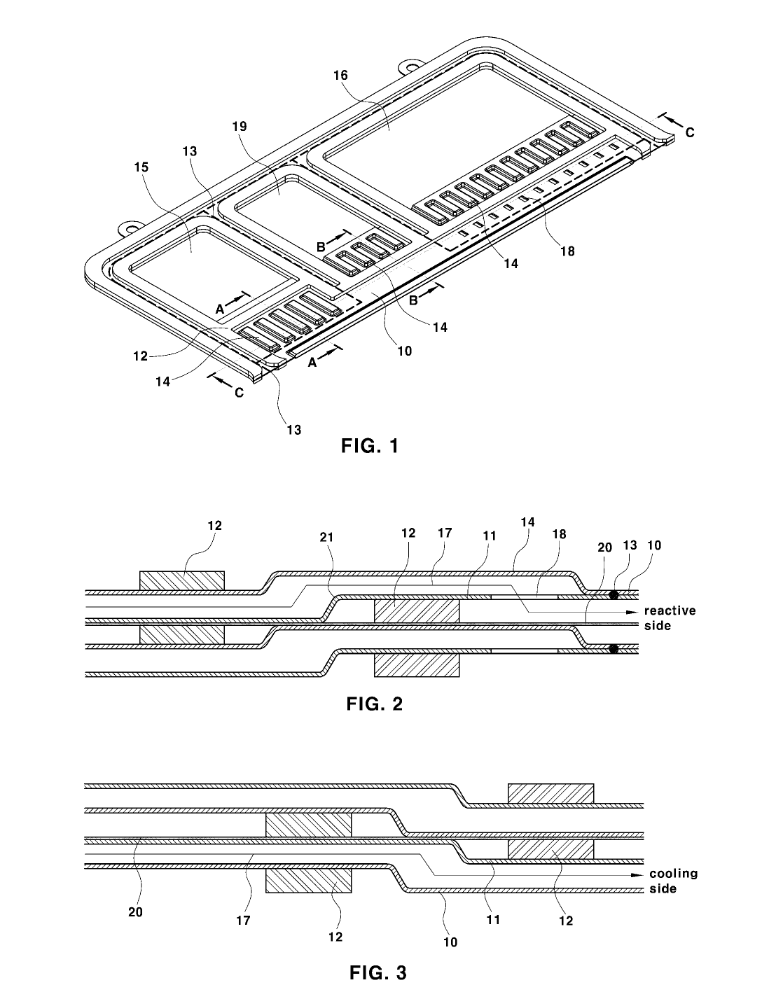

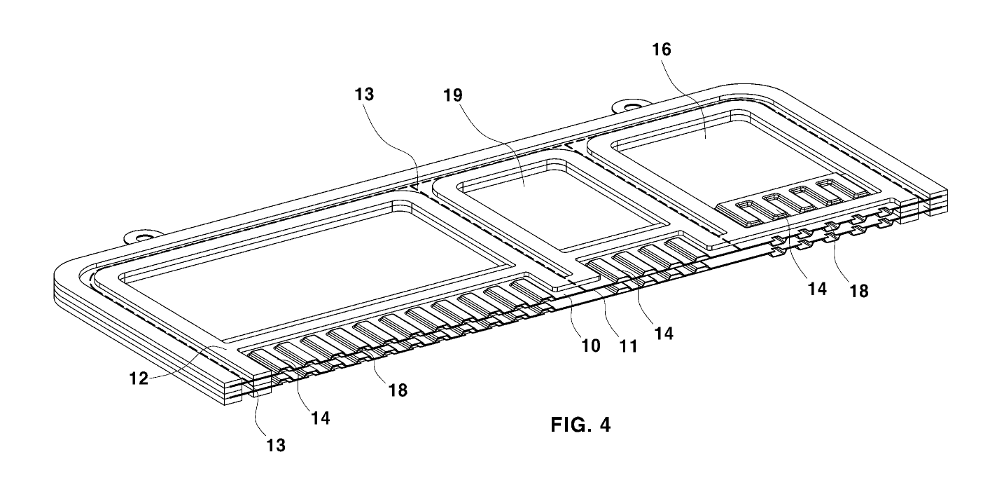

FIGS. 1 to 4 are perspective and cross-sectional views showing a metal separator of a fuel cell stack according to an embodiment of the present disclosure.

As shown in FIGS. 1 to 4, the metal separator is composed of a pair of an anode separator 10 and a cathode separator 11 as one set. A plurality of the separators are stacked in series with a membrane electrode assembly (MEA) 20 and a gas diffusion layer (GDL (not shown)) therebetween, thereby forming a fuel cell stack.

A gasket 12 for maintaining airtightness for a reactive gas (hydrogen or air) is bonded between the anode separator 10 and the cathode separator 11. For example, it is bonded between the anode separator 10 of one set and the cathode separator 11 of another set. The gasket 12 elongates along the entire edge of the separator. The edges of each manifold 15, 16, and 19 can be bonded by laser bonding or an adhesive.

The anode separator 10 and the cathode separator 11 are stacked and integrated in one set by a bonding portion 13 formed at contact portions therebetween.

That is, the anode separator 10 and the cathode separator 11 are vertically bonded as the one set by the bonding portion 13.

The bonding portion 13 may be implemented by laser bonding or an adhesive. The bonding portion 13, as illustrated in a dotted line in FIG. 1, is formed along the entire edge of the separator, along an edge of a forming support 14 and inlet holes 18 on a hydrogen manifold 15, and along an edge of the forming support 14 on an air manifold 16.

The forming support 14, which functions as a channel through which the reactive gas and cooling water flow and functions as structural supports to support the metal separator, are formed at an inlet and an outlet connected with the manifold.

The forming support 14 may protrude above the separator, that is, the forming support 14 may have a height corresponding to a thickness of the gasket 12.

A plurality of forming supports 14 may be provided for each manifold 15, 16, and 19. The forming supports 14 may be arranged side by side in a longitudinal direction of the metal separator (a flowing direction of the reactive gas or cooling water) and arranged at a predetermined interval in a width direction of the metal separator.

The forming support 14 may be formed on the anode separator 10 and/or the cathode separator 11 and may be formed on the anode separator 10 in an exemplary embodiment of the present disclosure.

Referring to FIG. 2, when the forming support 14 is formed on the anode separator 10 and the cathode separator 11 as in one set of separator, a bending portion 21 bending toward the forming support 14 is formed on the cathode separator 11 at a position corresponding to the forming support 14 on the anode separator 10. The gasket 12 may be disposed underneath the bending portion 21 which can functions as a forming support.

Accordingly, the forming supports 14 of the one set also support the adjacent sets (with the MEA 20 therebetween), such that they can function as supports instead of the gasket in the related art.

A channel 17 is provided for supplying the reactive gas and cooling water, in which there are a hydrogen channel formed toward a reactive side from the hydrogen manifold 15, a cooling water channel formed toward a cooling side from a cooling water manifold 19, and an air channel formed toward the reactive side from the air manifold 16.

The channel 17 is formed between the anode separator 10 and the cathode separator 11 in one set and may continue from the inlet/outlet, which are in contact with a manifold side, to a space between the forming supports 14 and the bending portion 21.

The inlet holes 18 are formed at the cathode separator 11 in which the channel 17 is formed inside the forming supports 14 on the anode separator 10, such that the channel 17 from the inlet and the outlet to the space between the forming supports 14 and the bending portion 21 can be continued to the reactive side by the inlet holes 18.

Accordingly, the reactive gas such as hydrogen that is supplied to the reactive side can flow into the channel 17 formed inside the forming supports 14 on the separator and can be supplied to the reactive side through the inlet holes 18. Further, the cooling water that is supplied to the cooling side can flow into the channel 17 formed inside the forming supports 14 and can be supplied directly to the cooling side through the channel 17.

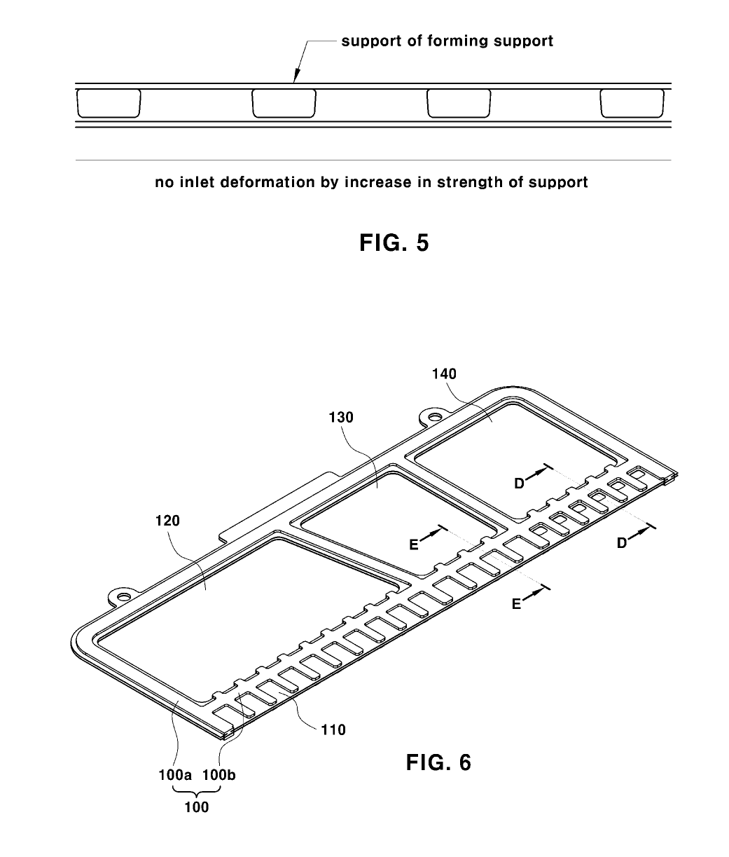

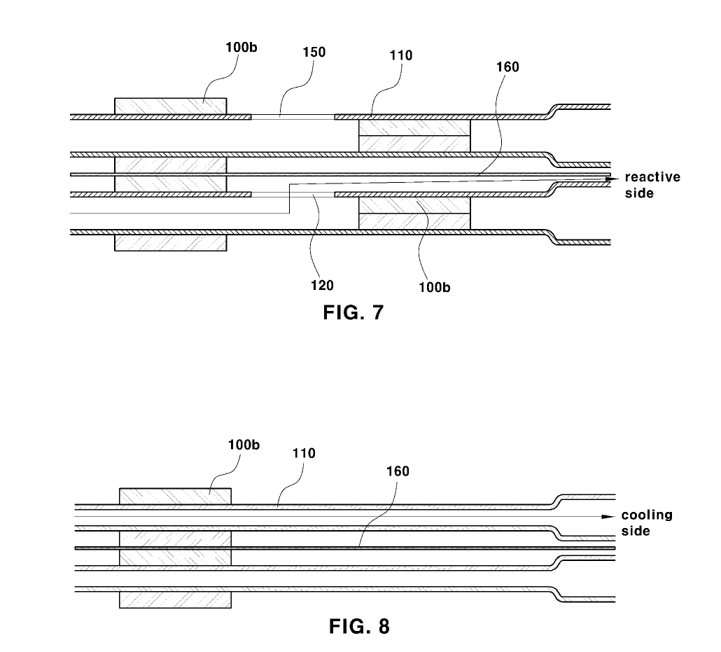

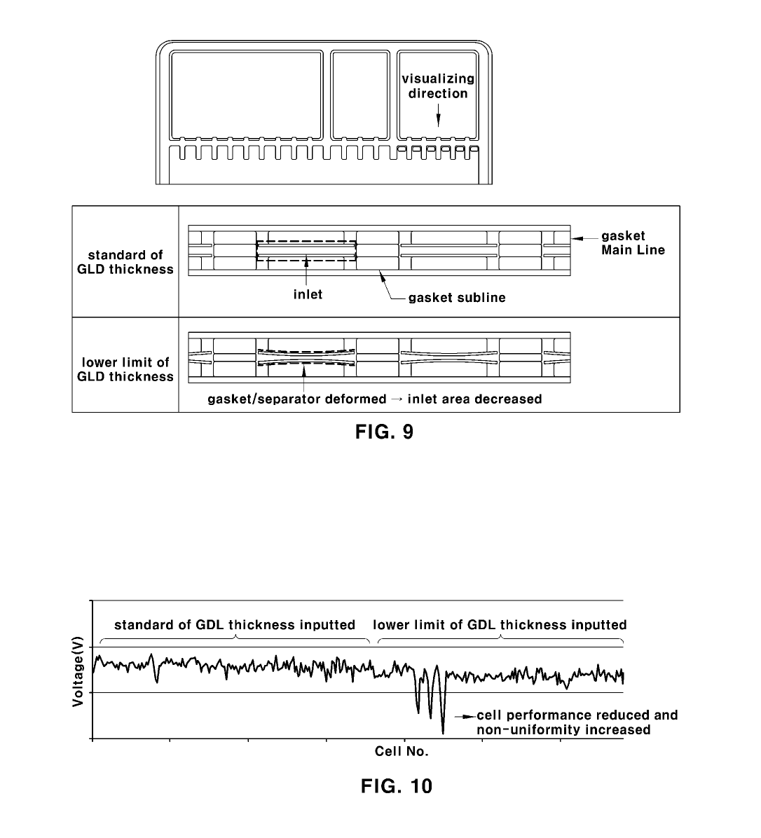

FIG. 5 shows an inlet and an outlet of the present disclosure, in which fuel cells were made to compare with an existing structure of FIG. 9.

In FIG. 9, an inlet area of the existing structure is reduced due to deformation of a gasket and separators, but in the present disclosure, the inlet and the outlet are maintained by the forming supports due to increased strength.

According to the exemplary embodiment of the present disclosure, in a fuel cell stack in which a plurality of separators are stacked in series with a thickness tolerance of the separators and GDLs, it is possible to uniformly distribute a reactive gas and cooling water to the cells, and accordingly, it is possible to improve the performance and the durability of the fuel cell stack.

According to another exemplary embodiment of the present disclosure, the forming supports 14 may be formed in opposite directions on the anode separator 10 and the cathode separator 11. For example, the forming supports 14 on the anode separator 10 may be formed upwardly, and the forming supports 14 on the cathode separator 11 may be formed downwardly, thus overlapping each other in a predetermined section.

More specifically, with respect to a flowing direction of the reactive gas or the cooling water, the forming supports 14 formed upwardly may be arranged at a front side (manifold side), and the forming supports 14 formed downwardly may be arranged at a rear side (reactive side). The forming supports 14 at the front side and the forming supports 14 at the rear side may partially overlapping each other (a rear portion of the forming support at the front side and a front portion of the forming support at the rear side may overlap each other). Wherein, the gasket line may be disposed in non-overlapping sections.

The present disclosure has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A metal separator for a fuel cell stack, comprising:
an anode separator;
a cathode separator; and
a gasket for maintaining airtightness for a reactive gas,
wherein the anode separator and the cathode separator are integrated in one set by a bonding portion formed at a contact portion between the anode separator and the cathode separator,
the gasket is bonded between the anode separator of the one set and the cathode separator of adjacent sets of the anode and cathode separators, and
forming supports that function as channels through which the reactive gas and a cooling water flow and function as structural supports are formed at an inlet and an outlet of the metal separator.

2. The metal separator of claim 1, wherein the bonding portion between the anode separator and the cathode separator is formed along the entire edge of the metal separator, an edge of a hydrogen manifold, and an edge of an air manifold.

3. The metal separator of claim 1, wherein the forming supports protrude above a top of the metal separator at a predetermined level.

4. The metal separator of claim 1, wherein the forming supports are arranged side by side in a longitudinal direction of the metal separator and arranged at a predetermined interval in a width direction of the metal separator.

5. The metal separator of claim 4, wherein the longitudinal direction is a flowing direction of the reactive gas or the cooling water.

6. The metal separator of claim 3, wherein the forming supports protrude to a height corresponding to a thickness of the gasket.

7. The metal separator of claim 1, wherein the reactive gas that is supplied to a reactive side flows into a channel formed inside the forming supports on the separator and is supplied to the reactive side through inlet holes formed through the metal separator.

8. The metal separator of claim 1, wherein the cooling water that is supplied to a cooling side flows into a channel formed inside the forming supports and is supplied to the cooling side through the channel.

9. The metal separator of claim 7, wherein the inlet holes are formed at the cathode separator.

10. The metal separator of claim 1, further comprising a bending portion formed on the cathode separator bent at a position corresponding to the forming supports on the anode separator.

11. The metal separator of claim 10, wherein the gasket is disposed underneath the bending portion.

12. The metal separator of claim 10, wherein the bending portion may be implemented by laser bonding or an adhesive.

13. The metal separator of claim 2, wherein the edges of each manifold can be bonded by laser bonding or an adhesive.

14. A metal separator for a fuel cell stack, comprising:
an anode separator;
a cathode separator; and
a gasket for maintaining airtightness for a reactive gas,
wherein the anode separator and the cathode separator are integrated in one set by a bonding portion formed at their contact portions,
the gasket is bonded between the anode separator of the one set and the cathode separator of adjacent sets of the anode and cathode separators,
forming supports that function as channels through which the reactive gas and a cooling water flow and function as structural supports are formed at an inlet and an outlet of the metal separator, and
the forming supports are formed on the anode separator and the cathode separator in opposite directions, the forming supports partially overlapping each other, and a gasket line is disposed in non-overlapping sections.
